(19) United States
(12) Patent Application Publication
(10) Pub. No.: US 2016/0274772 A1
(43) Pub. Date: Sep. 22, 2016

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Kanako Yamakawa, Kawasaki-shi (JP)

(21) Appl. No.: 15/070,910

(22) Filed: Mar. 15, 2016

(30) Foreign Application Priority Data
Mar. 17, 2015 (JP) 2015-053590

(51) Int. Cl. G06F 3/0484; G06T 3/60; G06T 11/00; G06T 5/00; G06F 3/0488; G06F 3/0482

(52) U.S. Cl. CPC G06F 3/04845; G06F 3/04883; G06F 3/0482; G06T 11/001; G06T 5/003; G06T 5/002; G06F 3/04842; G06T 3/60

(57) ABSTRACT

An information processing apparatus of this invention detects an editing operation for an object, and edits the object using a plurality of adjustment values calculated based on a detected adjustment value in the editing operation, thereby generating a plurality of first editing candidates. When two of the plurality of editing candidates are selected, the object is edited using a plurality of adjustment values calculated by subdividing the range of the adjustment values of the two selected editing candidates, thereby generating a plurality of second editing candidates.

### BACKGROUND OF THE INVENTION

1. Field of the Invention

The present invention relates to an information processing apparatus, an information processing method, and a program.

2. Description of the Related Art

In recent years, a lot of mobile devices such as portable telephone terminals, portable music players, and PDAs (Personal Digital Assistants) with touch screens have become commercially available. Accordingly, a number of applications compatible with a touch screen have been developed.

There is conventionally an input processing apparatus that rotates an image by an intuitive operation on a touch screen (see Japanese Patent Application Laid-Open No. 2010-257328). This input processing apparatus detects a rotation direction and a rotation angle from a rotation operation of drawing a circle by a finger, and rotates an image. A user can freely rotate a graphic because a rotation direction/rotation angle can be designated by drag processing.

However, some devices need a detailed editing operation when instructing editing processing for an object. In particular, when an operation member such as a touch screen is used, the operation is difficult for the user.

For example, in Japanese Patent Application Laid-Open No. 2010-257328, even if the user wants to rotate an image to an intended angle, it is difficult to finely designate the rotation angle by the touch and drag operation using a finger. The same problem arises in an application configured to set a parameter of image processing using a UI (User Interface) like a slide bar and process a target image. That is, in this application as well, it is difficult for the user to finely adjust the knob of the slide bar by the touch operation using a finger and designate a desired set value.

### SUMMARY OF THE INVENTION

The present invention has been made in consideration of the above-described problems, and enables to allow a user to implement setting of a precise adjustment value by a simple operation and obtain a desired object editing result.

According to the present invention, there is provided an information processing apparatus comprising a detection unit configured to detect an editing operation for an object, a first calculation unit configured to calculate a plurality of first adjustment values based on a detected adjustment value in the editing operation, a first editing unit configured to edit the object using each of the first plurality of adjustment values, a display unit configured to display, on a display, objects edited by the first editing unit as a plurality of first editing candidates, a second calculation unit configured to, when two of the plurality of first editing candidates are selected, calculate a plurality of second adjustment values by subdividing a range of the first adjustment values of the two selected first editing candidates, and a second editing unit configured to edit the object using each of the plurality of second adjustment values, wherein the display unit displays, on the display, objects edited by the second editing unit as second editing candidates.

Further features of the present invention will become apparent from the following description of exemplary embodiments with reference to the attached drawings.

### BRIEF DESCRIPTION OF THE DRAWINGS

FIG. 1 is a block diagram showing the arrangement of an information processing apparatus according to an embodiment of the present invention.

FIGS. 2A, 2B, 2C and 2D are views showing an example of an operation screen according to an embodiment of the present invention.

FIG. 3 is a flowchart showing an example of image processing according to an embodiment of the present invention.

FIGS. 4A, 4B, 4C, 4D and 4E are views showing an example of an operation screen according to an embodiment of the present invention.

FIG. 5 is a flowchart showing an example of image processing according to an embodiment of the present invention.

### DESCRIPTION OF THE EMBODIMENTS

### First Embodiment

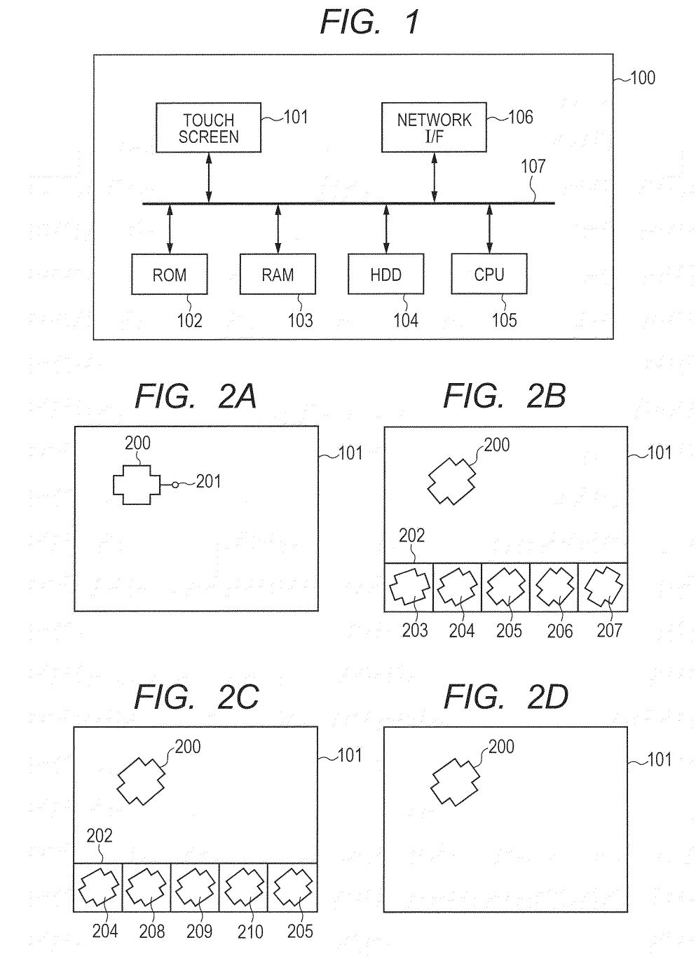

The first embodiment of the present invention will now be described with reference to the accompanying drawings. FIG. 1 is a block diagram showing the arrangement of an information processing apparatus 100 according to this embodiment. The information processing apparatus 100 includes a touch screen 101, a ROM 102, a RAM 103, a hard disk (to be referred to as an HDD hereinafter) 104, a CPU (Central Processing Unit) 105, a network I/F 106, and a bus 107.

The touch screen 101 serving as a display and display unit includes an input surface with a touch sensor and a display serving as a display screen. The touch screen 101 is planarly formed by overlaying the touch sensor on the display. The touch screen 101 is an input device that outputs coordinate information representing a position on the input surface that an indicator touches.

The touch screen 101 has a display function of displaying, on the display, image data generated by the CPU 105 according to a program and thumbnail image data (thumbnail) generated by reducing the image data. The touch screen 101 also has an input function of detecting the touch of the indicator by the touch sensor and inputting detection information to the CPU 105 as an electric signal. The touch screen 101 can be of any type such as a resistance film type, a capacitance type, a surface acoustic wave type, an infrared-ray type, an electromagnetic induction type, an image recognition type, and a photo-sensor type.

The ROM 102 stores various kinds of control programs such as a touch input program and data. The RAM 103 has a work area for the CPU 105, a data save area in error processing, a control program load area, and the like. The HDD 104 stores image data and thumbnail image data (thumbnails) to be displayed on the touch screen 101, control programs to be executed in the information processing apparatus 100, and temporarily saved data. The CPU 105 controls each device based on the OS and control programs stored in the ROM 102 and the HDD 104. Note that the functions and processes of the information processing apparatus 100 to be described later are implemented when the CPU 105 reads out the programs stored in the ROM 102 or the HDD 104 and executes the programs.

The CPU 105 executes various kinds of control programs, thereby accepting a user operation on the touch screen 101 and detecting an operation state according to the user operation. Operation states include a touch down, a touch on, a drag, a touch up, and a touch off. The touch down is a state in which an operation of touching the touch screen 101 with an indicator such as a finger or a pen has been performed. The touch on is a state in which the indicator is touching the touch screen 101. The drag is a state in which the indicator is moving while keeping touching the touch screen. The touch up is a state in which an operation of releasing the indicator touching the touch screen 101 from the touch screen 101 has been performed. The touch off is a state in which nothing touches the touch screen 101.

Input operations include a tap and a drag. The tap is an operation of touching the touch screen 101 with the indicator for a relatively short predetermined time or less (an operation of performing a touch up after detection of a touch down). The drag is an input operation of moving the indicator kept touching the touch screen 101 for a long time. The CPU 105 identifies an operation input via the touch screen 101 based on these operations and coordinates representing a position at which the indicator touches the touch screen 101.

The network I/F 106 communicates with another information processing apparatus, a printer, or the like via a network. The touch screen 101, the ROM 102, the RAM 103, the HDD 104, the CPU 105, and the network I/F 106 are connected to the bus 107 and configured to write/read data to/from each other via the bus 107. The bus 107 includes an address bus, a data bus, and a control bus. A control program can be provided to the CPU 105 from the ROM 102 or the HDD 104 or from another information processing apparatus via the network I/F 106 and a network.

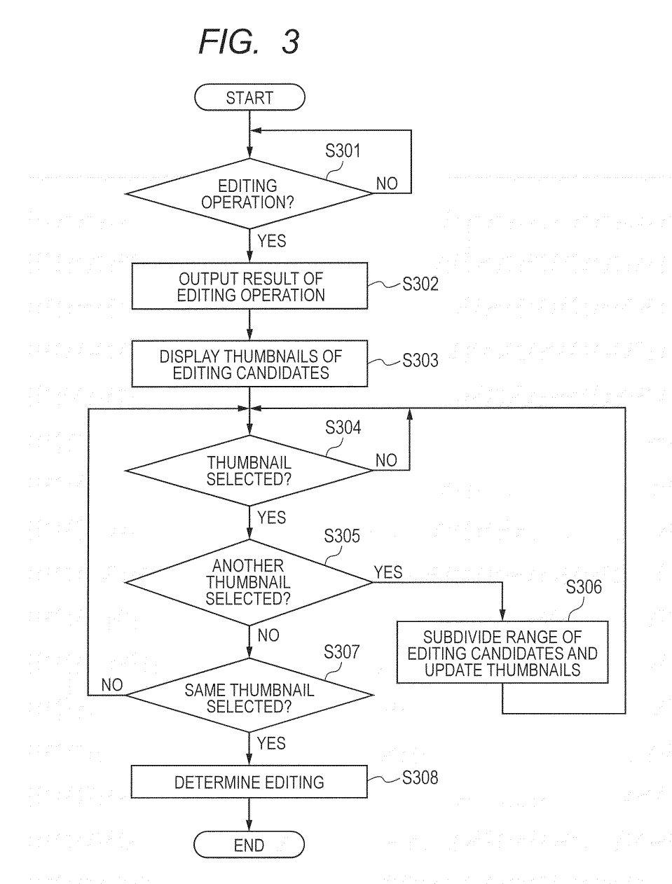

The editing operation of the information processing apparatus 100 according to this embodiment will be described next. In this embodiment, an example in which the user performs rotation editing to a desired angle for graphic data displayed on the touch screen 101 will be described. FIGS. 2A to 2D are views showing examples of a user operation screen. FIG. 3 is a flowchart showing an example of image processing. A description will be made below according to the flowchart of FIG. 3 with reference to FIGS. 2A to 2D. The CPU 105 of the information processing apparatus 100 activates the OS and a touch input program and controls the units in accordance with them, thereby implementing the following processing. Note that a graphic 200 shown in FIGS. 2A to 2D indicates graphic data to be subjected to rotation editing, and rotation processing of the graphic 200 executed in accordance with user operations is illustrated.

In step S301, the CPU 105 determines whether an editing operation of the graphic 200 is detected. More specifically, the CPU 105 determines whether the user has dragged a rotation handle 201 by a finger to perform a rotation operation of the graphic 200. If the editing operation is performed (YES in step S301), the CPU 105 determines that the adjustment value (rotation angle) of rotation editing of the graphic 200 is changed, and advances to step S302. If the editing operation is not performed (NO in step S301), the CPU 105 determines that the adjustment value of rotation editing of the graphic 200 is not changed, and returns to step S301.

In step S302, the CPU 105 outputs a result of the editing operation of the graphic 200 performed in step S301. More specifically, the CPU 105 calculates the rotation direction and the rotation angle from the positions of the rotation handle 201 before and after the drag operation and the central position of the graphic 200, rotates the graphic 200 by the calculated rotation angle, and displays the graphic 200 on the touch screen 101.

FIG. 2A shows a state in which the user can perform rotation editing of the graphic 200 by the drag operation. The user drags the rotation handle 201 in a circle, that is, clockwise or counterclockwise with a finger. The CPU 105 calculates the rotation direction and the rotation angle from the positions of the rotation handle before and after the drag operation, and rotates the graphic 200 about its central position. For example, if the coordinates of the central position of the graphic 200 are (0, 0), the coordinates of the rotation handle before the drag operation are (x0, y0), and the coordinates of the rotation handle after the drag operation are (x1, y1), the rotation angle is calculated in the following way. Using the inverse function of a trigonometric function tan, that is, an arctangent arctan, the rotation angle can be calculated by angle θ=arctan((y1−y0)/(x1−x0)).

In step S303, the CPU 105 calculates the rotation angles of a plurality of editing candidates based on the rotation angle calculated in step S302. The CPU 105 generates thumbnails 203 to 207 of the editing candidates by rotating the graphic 200 by the calculated rotation angles, and displays them in a thumbnail display area 202. For example, if the graphic 200 is rotated by 40° in step S302, the rotation angle of the graphic 200 of the thumbnail 205 displayed at the center of the thumbnail display area 202 is 40° likewise. As for the rotation angles of the thumbnails 203, 204, 206, and 207, the rotation angle (40°) of the graphic 200 is used as a reference, and rotation angles larger and smaller than the reference rotation angle are calculated at a predetermined interval. The CPU 105 rotates the graphic 200 at the calculated rotation angles, thereby generating the thumbnails of the editing candidates. The amount of the interval used in step S303 may be a predetermined value or a value set by the user.

FIG. 2B shows display on the touch screen 101 after the user has designated the rotation angle as the reference by the drag operation. The CPU 105 displays the thumbnails 203 to 207 obtained by rotating the graphic 200 in accordance with the calculated rotation angles of the editing candidates in a line in the thumbnail display area 202. The rotation angle of the thumbnail 205 displayed at the center of the thumbnail display area 202 equals the rotation angle of the graphic 200 displayed on the touch screen 101. For example, if the graphic 200 is rotated by 40° upon the rotation operation by the drag operation of the user, the thumbnail 205 corresponds to the graphic 200 rotated by 40°. As for the rotation angles of the thumbnails 203, 204, 206, and 207, the rotation angle (40°) of the graphic 200 is used as a reference, and rotation angles larger and smaller than the reference rotation angle are decided at equal intervals. For example, if the interval is 10°, the rotation angles of the thumbnails 203, 204, 206, and 207 of the candidates are decided by performing subtraction and addition for the reference rotation angle (40°). Hence, in FIG. 2B, the rotation angle of the thumbnail 203 is 20°, the rotation angle of the thumbnail 204 is 30°, the rotation angle of the thumbnail 206 is 50°, and the rotation angle of the thumbnail 207 is 60°. To more finely edit the rotation angle, the user selects two thumbnails close to a desired rotation processing result from the thumbnails 203 to 207 by a touch operation.

In step S304, the CPU 105 determines whether one of the thumbnails 203 to 207 displayed in step S303 is selected by a touch operation of the user. If one of the thumbnails 203 to 207 is selected (YES in step S304), the CPU 105 determines that one thumbnail is selected, and advances to step S305. If none of the thumbnails 203 to 207 is selected (NO in step S304), the CPU 105 determines that no thumbnail is selected, and returns to step S304.

In step S305, the CPU 105 determines whether another thumbnail different from the thumbnail selected in step S304 is selected by a touch operation of the user. If another thumbnail is selected (YES in step S305), the CPU 105 determines to subdivide the editing candidates, and advances to step S306. If another thumbnail is not selected (NO in step S305), the CPU 105 determines that another thumbnail is not selected, and advances to step S307.

In step S306, the CPU 105 calculates the rotation angles of editing candidates by subdividing the range of the rotation angles of the two thumbnails selected in steps S304 and S305, generates the thumbnails of the rotation angles, and updates the display in the thumbnail display area 202. For example, if in FIG. 2B, the thumbnails 204 and 205 are selected, the rotation angle of the graphic 200 of the thumbnail 204 is 30°, and the rotation angle of the graphic 200 of the thumbnail 205 is 40°, the CPU 105 performs processing in the following way. That is, the CPU 105 arranges the thumbnails 204 and 205 at the two ends of the thumbnail display area 202, generates thumbnails 208 to 210 of the graphic 200 rotated by rotation angles that subdivide the range of 30° to 40°, and displays them in the thumbnail display area 202. This also applies to a case in which the thumbnails 204 and 207 are selected in FIG. 2B. The thumbnails 204 and 207 are arranged at the two ends of the thumbnail display area 202. If the rotation angle of the thumbnail 207 is 60°, thumbnails of the graphic 200 rotated by rotation angles that subdivide the range of 30° to 60° are generated and displayed in the thumbnail display area 202.

FIG. 2C shows display on the touch screen 101 after the user has selected the thumbnails 204 and 205 in FIG. 2B. The CPU 105 calculates the rotation angles of editing candidates by subdividing the range of the rotation angles of the thumbnails 204 and 205, arranges the thumbnails 208 to 210 generated by rotating the graphic 200 by the calculated rotation angles between the thumbnails 204 and 205, and displays them in the thumbnail display area 202. The rotation angles of the graphics 200 of the thumbnails 208 to 210 are decided at equal or almost equal intervals within the range of the change width between the rotation angles of the graphics 200 of the thumbnails 204 and 205. For example, if the rotation angle of the graphic 200 is 30° in the thumbnail 204 and 40° in the thumbnail 205, the rotation angle of the thumbnail 208 is 32.5°, the rotation angle of the thumbnail 209 is 35°, and the rotation angle of the thumbnail 210 is 37.5°.

In step S307, the CPU 105 determines whether a thumbnail having the same rotation angle as the thumbnail selected in step S304 is selected by a touch operation of the user. If the thumbnail having the same rotation angle is selected (YES in step S307), the CPU 105 determines that the thumbnail of the editing candidate desired by the user is selected, and advances to step S308. If the thumbnail having the same rotation angle is not selected (NO in step S307), the CPU 105 determines that the thumbnail of the editing candidate desired by the user is not selected, and returns to step S304.

In step S308, the CPU 105 determines the editing of the graphic 200, and decides the rotation angle of the thumbnail selected in step S307 as the adjustment value of the rotation editing of the graphic 200. More specifically, the CPU 105 rotates the graphic 200 by the rotation angle of the thumbnail selected in step S307, displays it on the touch screen 101, disables the thumbnail display area 202, and ends the editing of the graphic 200.

FIG. 2D shows a state in which the user performs a touch operation twice on the thumbnail 209 in FIG. 2C, thereby determining the editing. The CPU 105 disables the thumbnail display area 202, and displays the graphic 200 rotated by the same angle as the thumbnail 209. For example, if the rotation angle of the thumbnail 209 is 35°, the CPU 105 rotates the graphic 200 by 35°, and determines the editing. Note that graphic data has been described above as an example of an object subjected to rotation processing. However, this embodiment can be implemented in a similar way even if the object is an image acquired by an image pickup apparatus. When generating a thumbnail of the graphic 200 after rotation editing, as described above, the graphic 200 is rotated, and the edited graphic is reduced to generate the thumbnail of an editing candidate. Alternatively, the graphic 200 is reduced to generate a thumbnail, and the thumbnail is rotated by a rotation angle to generate the thumbnail of an editing candidate.

As described above, in this embodiment, a plurality of editing candidates that have undergone rotation processing at a plurality of different rotation angles based on the rotation angle of an object edited by the user are displayed in a list. When two of the plurality of editing candidates are selected, the range of the rotation angles of the two selected editing candidates is subdivided to further generate a plurality of editing candidates having different rotation angles, and the list display is updated. In this way, only by repeating the operation of selecting an editing candidate close to a desired editing result from the editing candidates displayed in the list, the user can easily finely adjust the rotation angle of rotation editing of an object and obtain the object that has undergone rotation editing by the adjustment value of the desired rotation processing result.

### Second Embodiment

The second embodiment of the present invention will be described below. A description of parts common to the first embodiment will be omitted, and a characteristic arrangement of this embodiment will be described in detail.

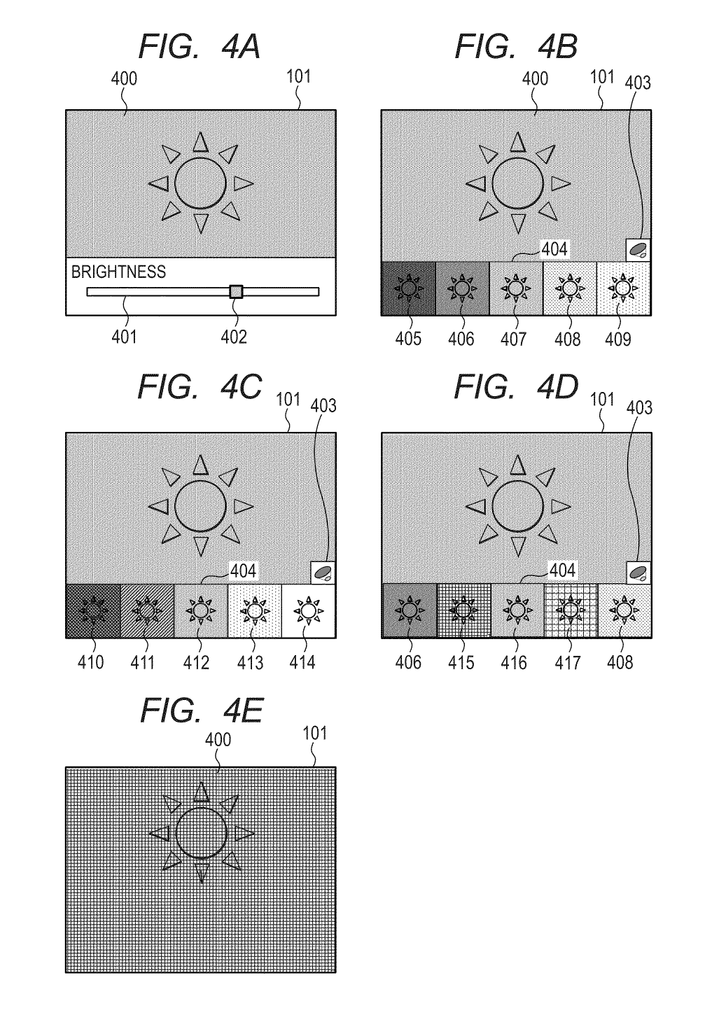

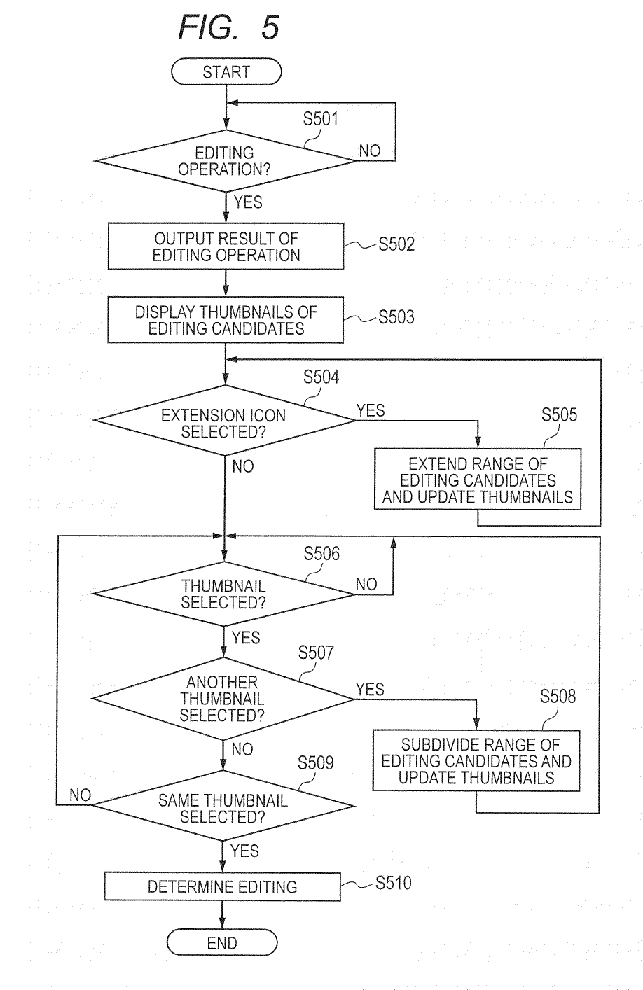

The editing operation of an information processing apparatus 100 according to this embodiment will be described with reference to FIGS. 4A to 4E and FIG. 5. FIGS. 4A to 4E are views showing examples of the operation screen of the information processing apparatus 100 according to this embodiment. FIG. 5 is a flowchart showing an example of image processing according to this embodiment. In this embodiment, an example in which the user performs image quality adjustment to a desired brightness as an editing operation for an object will be described. A CPU 105 of the information processing apparatus 100 activates the OS and a touch input program and controls the units in accordance with them, thereby implementing the following processing. Note that FIGS. 4A to 4E are views for explaining a fine adjustment operation of the adjustment value of the brightness of an image. An image 400 indicates image data to be edited.

In step S501, the CPU 105 determines whether an editing operation of the image 400 is performed. More specifically, the user drags a knob 402 of a slide bar 401 by a finger, and the CPU 105 detects the positions of the knob 402 before and after the movement, thereby determining whether brightness is adjusted. If the editing operation of the image 400 is performed (YES in step S501), the CPU 105 determines that the brightness of the image 400 is adjusted, and advances to step S502. If the editing operation of the image 400 is not performed (NO in step S501), the CPU 105 determines that the brightness of the image 400 is not adjusted, and returns to step S501.

In step S502, the CPU 105 outputs a result of the editing operation in step S501 on the image 400. More specifically, the CPU 105 adjusts the quality of the image 400 based on the brightness adjusted in step S501. The CPU 105 detects the position of the knob 402 moved by the drag operation of the user, adjusts the quality of the image 400 to the brightness value corresponding to the detected position, and displays the image 400 on a touch screen 101.

FIG. 4A shows a state in which the user can adjust the brightness value of the image 400. The user can adjust the brightness value by dragging the knob 402 on the slide bar 401. The CPU 105 detects the position of the knob 402 after the drag operation of the user, obtains the brightness value, and adjusts the quality of the image 400. For example, if values settable by the slide bar 401 range from −127 to +127, and the position of the knob 402 after the drag operation is +50, the CPU 105 adds +50 to each of the RGB values (0 to 255) of the image 400, thereby calculating the brightness value after adjustment. The CPU 105 displays the image 400 that has undergone the brightness adjustment on the touch screen 101.

In step S503, the CPU 105 calculates a plurality of brightness value candidates using the brightness value obtained in step S502 as a reference, generates thumbnails 405 to 409 of editing candidates by adjusting the quality of the image 400 to the brightness values, and displays them on the touch screen 101.

FIG. 4B shows a state immediately after the user has designated a brightness value by dragging the knob 402. The thumbnails 405 to 409 of editing candidates whose median is the brightness value set by the slide bar 401 are displayed in a thumbnail display area 404 of the touch screen 101. The brightness value of the thumbnail 407 is the same as the image 400. For example, if the image 400 is set to a brightness value of +50 by the drag operation, the thumbnail 407 is also an image processed to the brightness value of +50. As for the brightness values of the thumbnails 405, 406, 408, and 409, the brightness value (+50) of the image 400 is used as a reference, and brightness values higher and lower than the reference brightness are decided at equal intervals. For example, if the initial interval is 10, the brightness values of the thumbnails are set to +30 for the thumbnail 405, +40 for the thumbnail 406, +60 for the thumbnail 408, and +70 for the thumbnail 409. That is, using the brightness value of the thumbnail 407 as a reference, the thumbnails 405 and 406 are quality-adjusted as thumbnails darker than the thumbnail 407, and the thumbnails 408 and 409 are quality-adjusted as thumbnails lighter than the thumbnail 407. Note that as the brightness value interval, a predetermined value may be used, or the user may be allowed to arbitrarily set the interval.

In step S504, the CPU 105 determines whether an extension icon 403 is selected by the user. The extension icon 403 is an icon displayed on the touch screen 101, as shown in FIG. 4B. The extension icon 403 is an icon used to extend the interval of the brightness values of the displayed thumbnails 405 to 409 of the editing candidates. The CPU 105 determines whether an indicator has touched a position where the extension icon 403 is displayed, thereby determining whether the extension icon 403 is selected. If the extension icon 403 is selected (YES in step S504), the CPU 105 determines that a request to extend the interval of the brightness values of the thumbnails 405 to 409 is input, and advances to step S505. If the extension icon 403 is not selected (NO in step S504), the CPU 105 determines that a request to extend the interval of the brightness values of the thumbnails 405 to 409 is not input, and advances to step S506.

In step S505, the CPU 105 extends the interval of the brightness values of the thumbnails 405 to 409 of the editing candidates, adjusts the quality, and updates the thumbnails 405 to 409 displayed in the thumbnail display area 404. As the brightness interval, a value larger than the interval value used in step S503 is employed. The brightness value of the thumbnail displayed at the center of the thumbnail display area 404 after extension equals the brightness value of the image 400 set in step S501. Using the brightness value of +50 set in step S501 as a reference, the CPU 105 calculates the brightness values of the thumbnails at equal intervals using an interval wider than the interval used in step S503, for example, a multiple of the initial value of the interval. When the brightness value interval is extended in this way, the range of the brightness values of thumbnails 410 to 414 is also extended, and the user can freely adjust the brightness value.

The CPU 105 arranges the thumbnails at the extended brightness value interval in the thumbnail display area 404 in ascending order of brightness, updates the display, and returns to step S504. In this way, when the extension icon 403 is selected, the CPU 105 extends the interval of the brightness values of the thumbnails 410 to 414. When brightness value interval extension is repetitively performed, display in the thumbnail display area 404 is updated to thumbnails whose brightness value interval is extended using an interval wider than the preceding interval. This makes it possible to easily search for an image of a desired brightness. Note that the range of brightness values of the thumbnails displayed in the thumbnail display area 404, that is, the minimum value of brightness represented by the thumbnail 410 and the maximum value of brightness represented by the thumbnail 414 can be extended within a range settable in the information processing apparatus 100.

FIG. 4C shows a state immediately after the user has selected the extension icon 403 in FIG. 4B. The thumbnails 410 to 414 that have undergone image quality adjustment to brightness values at a wider interval while setting the medium to the brightness value of the thumbnail 407 that is the reference value of the brightness value in FIG. 4B are displayed in a line. For example, the thumbnail 412 displayed at the center of the thumbnail display area 404 is a thumbnail that has undergone image quality adjustment to the brightness value of +50 that is the reference value. Using the brightness value of +50 as a reference, the brightness values of thumbnails higher and lower than the reference brightness are calculated at equal intervals. As the interval, a value larger than the interval of 10 in FIG. 4B is employed. For example, 20 that is a multiple of 10 is employed. When the interval value is set to 20, the brightness values of the thumbnails are set to +10 for the thumbnail 410, +30 for the thumbnail 411, +70 for the thumbnail 413, and +90 for the thumbnail 414. That is, using the brightness value of the thumbnail 412 as a reference, the thumbnails 410 and 411 are quality-adjusted as thumbnails darker than the thumbnail 412, and the thumbnails 413 and 414 are quality-adjusted as thumbnails lighter than the thumbnail 412.

In step S506, the CPU 105 determines whether one of the thumbnails 405 to 409 displayed in step S503 or one of the thumbnails 410 to 414 updated in step S505 is selected by the user. If one of the thumbnails 405 to 409 or the thumbnails 410 to 414 is selected (YES in step S506), the CPU 105 determines that a desired thumbnail is selected, and advances to step S507. If none of the thumbnails 405 to 409 or the thumbnails 410 to 414 is selected (NO in step S506), the CPU 105 determines that no thumbnail is selected, and returns to step S506.

In step S507, the CPU 105 determines whether another thumbnail different from the thumbnail selected in step S506 is selected by the user. If another thumbnail is selected (YES in step S507), the CPU 105 determines that a request to subdivide the brightness values of the thumbnails of the editing candidates is input, and advances to step S508. If another thumbnail is not selected (NO in step S507), the CPU 105 determines that a request to subdivide the brightness values of the thumbnails of the editing candidates is not input, and advances to step S509.

In step S508, the CPU 105 calculates brightness values by subdividing the range of the brightness values of the two thumbnails selected in steps S506 and S507, and updates the display to thumbnails of the image 400 quality-adjusted to the calculated brightness values. More specifically, the CPU 105 subdivides the range of the brightness values of the two selected thumbnails at equal or almost equal intervals, generates thumbnails of the image 400 quality-adjusted to the subdivided brightness values, and displays them in the thumbnail display area 404.

FIG. 4D shows a result obtained when the user selects the thumbnails 406 and 408 in FIG. 4B and arranges the thumbnails at the two ends of the thumbnail display area 404, and the brightness values of the thumbnails of editing candidates are subdivided and displayed.

Thumbnails 415 to 417 are arranged and displayed in a line between the selected thumbnails 406 and 408. The brightness values of the thumbnails 415 to 417 are decided at equal or almost equal intervals within the range of the brightness values of the thumbnails 406 and 408. For example, if the thumbnail 406 is a thumbnail quality-adjusted to +40, and the thumbnail 408 is a thumbnail quality-adjusted to +60, the range of +40 to +60 is changed at equal intervals to set a brightness value of +45 for the thumbnail 415, +50 for the thumbnail 416, and +55 for the thumbnail 417.

In step S509, the CPU 105 determines whether the thumbnail selected in step S506 is selected again by the user. More specifically, the CPU 105 determines whether the user has tapped twice the thumbnail having the same brightness value. If the thumbnail having the same brightness value is selected (YES in step S509), the CPU 105 determines that the thumbnail of the brightness value desired by the user is selected, and advances to step S510. If the thumbnail having the same brightness value is not selected (NO in step S509), the CPU 105 determines that the thumbnail of the brightness value desired by the user is not selected, and returns to step S506.

In step S510, the CPU 105 determines the editing result of the image 400, and decides the brightness value of the thumbnail selected in step S509 as the adjustment value of the brightness adjustment of the image 400. More specifically, the CPU 105 displays, on the touch screen 101, an image obtained by quality-adjusting the image 400 to the brightness value of the thumbnail selected in step S509, disables the extension icon 403 and the thumbnail display area 404, and ends the image quality adjustment processing for brightness.

FIG. 4E shows a result obtained when the user taps the thumbnail 415 twice in FIG. 4D. The CPU 105 disables the thumbnail display area 404, and adjusts the image 400 to the same brightness value as the thumbnail 415. For example, if the thumbnail 415 is quality-adjusted to a brightness value of +45, the CPU 105 quality-adjusts the image 400 to the brightness value of +45, determines the editing, and displays the image. Note that when generating a thumbnail of the image 400 after image quality adjustment, as described above, the CPU 105 adjusts the image 400 to each brightness value, and reduces each adjusted image to generate the thumbnail of an editing candidate. Alternatively, the CPU 105 reduces the image 400 to generate a thumbnail, and adjusts the thumbnail to each brightness value to generate the thumbnail of an editing candidate.

As described above, in this embodiment, a plurality of editing candidates that have undergone adjustment processing to a plurality of different adjustment values based on the adjustment value of an object edited by the user are displayed in a list. When two of the plurality of editing candidates are selected, the range of the adjustment values of the two selected editing candidates is subdivided to further generate a plurality of editing candidates having a plurality of different adjustment values, and the list display is updated. In this way, only by repeating the operation of selecting an editing candidate close to a desired editing result from the editing candidates displayed in the list, the user can easily finely adjust an object. In addition, not only by subdividing the range of adjustment values but also by generating editing candidates having extended adjustment values and displaying them in a list, the user can perform fine adjustment using an adjustment value close to a desired editing result out of broader choices.

### Other Embodiments

Note that the present invention is not limited to the above-described embodiments, and various changes and modifications can be made within the spirit and scope of the present invention. For example, in the second embodiment, an example in which the brightness value of image processing is edited as an editing operation using a slide bar has been described. The embodiment is also applicable to contrast, hue, saturation, sharpness, tint, color density, and noise alleviation which can be edited by a slide bar.

In the second embodiment, processing of extending the interval of the brightness values of the thumbnails 405 to 409 according to an operation on the extension icon 403 displayed on the touch screen 101 has been described. However, the processing of extending the interval may be applied to the first embodiment.

In the above-described embodiments, an example in which five thumbnails of editing candidates are displayed in a line has been described. However, the number of editing candidates to be arranged in a line may be larger or smaller, as a matter of course. However, a number that allows the user to determine the difference between thumbnails and easily select one by a touch operation using a finger should be employed.

In the above-described embodiments, editing is determined when a thumbnail having the same adjustment value is selected twice out of the thumbnails of editing candidates. However, editing may be determined when, for example, one thumbnail is kept selected by the indicator for a predetermined time.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-053590, filed Mar. 17, 2015, which is hereby incorporated by reference herein in its entirety.

What is claimed is:

1. An information processing apparatus comprising:
a detection unit configured to detect an editing operation for an object;
a first calculation unit configured to calculate a plurality of first adjustment values based on a detected adjustment value in the editing operation;
a first editing unit configured to edit the object using each of the plurality of first adjustment values;
a display unit configured to display, on a display, objects edited by the first editing unit as a plurality of first editing candidates;
a second calculation unit configured to, when two of the plurality of first editing candidates are selected, calculate a plurality of second adjustment values by subdividing a range of the first adjustment values of the two selected first editing candidates; and
a second editing unit configured to edit the object using each of the plurality of second adjustment values,
wherein the display unit displays, on the display, objects edited by the second editing unit as second editing candidates.

2. The information processing apparatus according to claim 1, wherein the first calculation unit calculates the plurality of first adjustment values by subtracting or adding a predetermined amount from or to the adjustment value corresponding to the editing operation.

3. The information processing apparatus according to claim 1, wherein the detection unit detects the editing operation for the object based on a position of an indicator touching the display and a change in the position.

4. The information processing apparatus according to claim 1, further comprising a decision unit configured to, when an adjustment value of a first editing candidate selected from the plurality of first editing candidates equals an adjustment value of a second editing candidate selected from the plurality of second editing candidates, decide the adjustment value as the adjustment value of the editing operation for the object.

5. The information processing apparatus according to claim 1, further comprising a third calculation unit configured to calculate third adjustment values by extending an interval of the second adjustment values; and
a third editing unit configured to edit the object using each of the third adjustment values,
wherein the display unit displays, on the display, the object edited by the third editing unit as third editing candidates.

6. The information processing apparatus according to claim 1, wherein the object is one of a graphic and an image, and the editing operation for the object is rotation processing for the object.

7. The information processing apparatus according to claim 1, wherein the object is an image, and the editing operation for the object is at least one of adjustment of brightness, adjustment of contrast, adjustment of hue, adjustment of saturation, adjustment of tint, adjustment of color density, adjustment of sharpness, and adjustment of noise alleviation for the object.

8. An information processing method comprising:
detecting an editing operation for an object;
calculating a plurality of first adjustment values based on an adjustment value corresponding to the editing operation;
editing the object using each of the plurality of first adjustment values;
displaying, on a display, edited objects as a plurality of first editing candidates;
when two of the plurality of first editing candidates are selected, calculating a plurality of second adjustment values by subdividing a range of the first adjustment values of the two selected first editing candidates;
editing the object using each of the plurality of second adjustment values; and
displaying, on the display, edited objects as second editing candidates.

9. A non-transitory computer-readable storage medium storing a program that causes a computer to execute:
detecting an editing operation for an object;
calculating a plurality of first adjustment values based on an adjustment value corresponding to the editing operation;
editing the object using each of the plurality of first adjustment values;
displaying, on a display, edited objects as a plurality of first editing candidates;
when two of the plurality of first editing candidates are selected, calculating a plurality of second adjustment values by subdividing a range of the first adjustment values of the two selected first editing candidates;
editing the object using each of the plurality of second adjustment values; and
displaying, on the display, edited objects as second editing candidates.
